(19) United States
(12) Patent Application Publication
(10) Pub. No.: US 2017/0253068 A1
(43) Pub. Date: Sep. 7, 2017

(54) CUSTOMIZABLE GREETING CARD WITH INTEGRATED ENVELOPE

(71) Applicant: Willis A. Fuller, Atlanta, GA (US)

(72) Inventor: Willis A. Fuller, Atlanta, GA (US)

(21) Appl. No.: 15/061,830

(22) Filed: Mar. 4, 2016

(51) Int. Cl. B42D 15/02; G06F 3/048; H04N 1/00; G06F 3/12; B42D 15/04; G06K 15/02

(52) U.S. Cl. CPC B42D 15/027; B42D 15/042; G06K 15/021; H04N 1/00129; H04N 1/00204; G06F 3/1284; G06F 3/048

(57) ABSTRACT

A method of creating a personalized greeting card including providing a paperboard template having a plurality of notches defining hinges and distinctive panels hinged from a central card portion; designing a customized greeting having user defined text and graphics using a computer interface; printing the customized greeting onto the paperboard template; and folding the distinctive panels onto the central card portion enclosing the customized greeting.

### TECHNICAL FIELD

The present invention relates to greeting cards in general and in particular to a greeting card with an integrated envelope which may be customized using software.

### BACKGROUND OF THE INVENTION

Greeting cards are well known to be presented to individuals at special occasions such as birthdays, anniversaries, Mother's Day and the like. While such cards are generally well received, they nonetheless are printed for the masses in vast quantities and convey generic messages. Such cards are devoid of any personal touches such as personal greetings or photos. Additionally, it is known to provide form paperboard templates which may be folded onto themselves for providing an envelope for a mailing.

While suitable for their intended purposes, the prior art fails to provide for a greeting card which may be customizable for specific individuals at a home environment and which contains an integrated envelope enabling the greeting card to be presented to the recipient.

Accordingly, there is a need for a customizable greeting card which enables a provider to personalize the greeting card at their residence on their personal computer and which may be sealed in a mailable envelope to be presented to a recipient.

### SUMMARY OF THE INVENTION

The above objective is accomplished according to the invention by providing a customizable greeting card. A paperboard structure is configured to be a customized greeting card displaying a customized message having a paperboard template sized for being received into a printer associated with a computing device.

In one aspect of the disclosure, a paperboard structure is configured to be a customized greeting card displaying a customized message. The paperboard structure comprises a paperboard template comprising a first portion oriented to encompass a second portion, and the first portion is configured to detach from the second portion. The second portion comprises a top panel including a top panel base-end and a top panel free-end including a securing member. The second portion comprises a bottom panel including a bottom panel free-end and a bottom panel base-end defining a securing member aperture sized to receive the securing member. The second portion further comprises a first side panel including a first side panel free-end and a first side panel base-end; and a second side panel including a second side panel free-end and a second side panel base-end. The second portion also comprises a central panel that includes a top seam, a bottom seam, a first side seam, and a second side seam. The top panel base-end is connected to the central panel at the top seam; the bottom panel base-end is connected to the central panel at the bottom seam; the first side panel base-end is connected to the central panel at the first side seam; and the second side panel base-end is connected to the central panel at the second side seam.

In another aspect of the disclosure, a system for creating a personalized greeting card includes: a computing device, a printing device, and a paperboard template. The computing device includes: a memory, a user interface, a display device, and a processor. The processor is in electronic communication with the memory, the user interface and the display device. The processor is configured to execute instructions to perform actions including: provide a customized display on the display device resembling the configuration of a paperboard template; receive input from the user interface; provide received input to the display device, and print the received input onto the paperboard template.

An additional aspect of the disclosure is a method of creating a personalized greeting card. The method comprises providing a paperboard template comprising a top panel, bottom panel, a first side panel, and a second side panel, each panel being connected to a central panel along a seam. The method comprises receiving printing data including text data and graphic data using a computing device comprising a user interface. The method further comprises displaying the received printing data from the user interface. The method also comprises outputting the received the printing data onto the paperboard template.

### DESCRIPTION OF THE DRAWINGS

The construction designed to carry out the invention will hereinafter be described together with other features thereof. The invention will be more readily understood from reading the following specification and by reference to the accompanying drawings forming a part thereof.

FIG. 1 is a schematic view depicting a surface of a paperboard template.

FIG. 1A is a schematic view depicting an opposite surface of the paperboard template in FIG. 1.

FIG. 2 is a schematic view of a portion of a paperboard template in FIG. 1.

FIG. 3 is a schematic view of a portion of a paperboard template in FIG. 2.

FIG. 3A is a schematic view of an alternative configuration of a paperboard template in FIG. 3.

FIG. 4 is a schematic view of a portion of a paperboard template in FIG. 2.

FIG. 5 is a schematic view of a portion of a paperboard template in FIG. 2.

FIG. 6 is a schematic front view of a portion of a paperboard template in FIG. 2.

FIG. 6A is a schematic rear view of the portion of the paperboard template in FIG. 6.

FIG. 7 illustrates a schematic of a customizable greeting card system according to the present invention.

### DESCRIPTION OF THE PREFERRED EMBODIMENT

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is it to be construed to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C . . . sctn. 112, 6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiments is merely exemplary in nature and is in no way intended to limit the invention, its implementations, or uses.

### A. Brief Additional Description Relating to the Systems and Methods for Producing a Customizable Greeting Card.

The invention consists of the utilization of computer instructions in combination with a paperboard template which enables customizable greeting card to be produced. The greeting card can be produced in a manner which allows for the card to be folded into a self contained envelope. One surface of the paperboard template can be configured to display the customized greeting. A second surface can be customized to receive mailing postage and/or a recipient's mailing information including name and address.

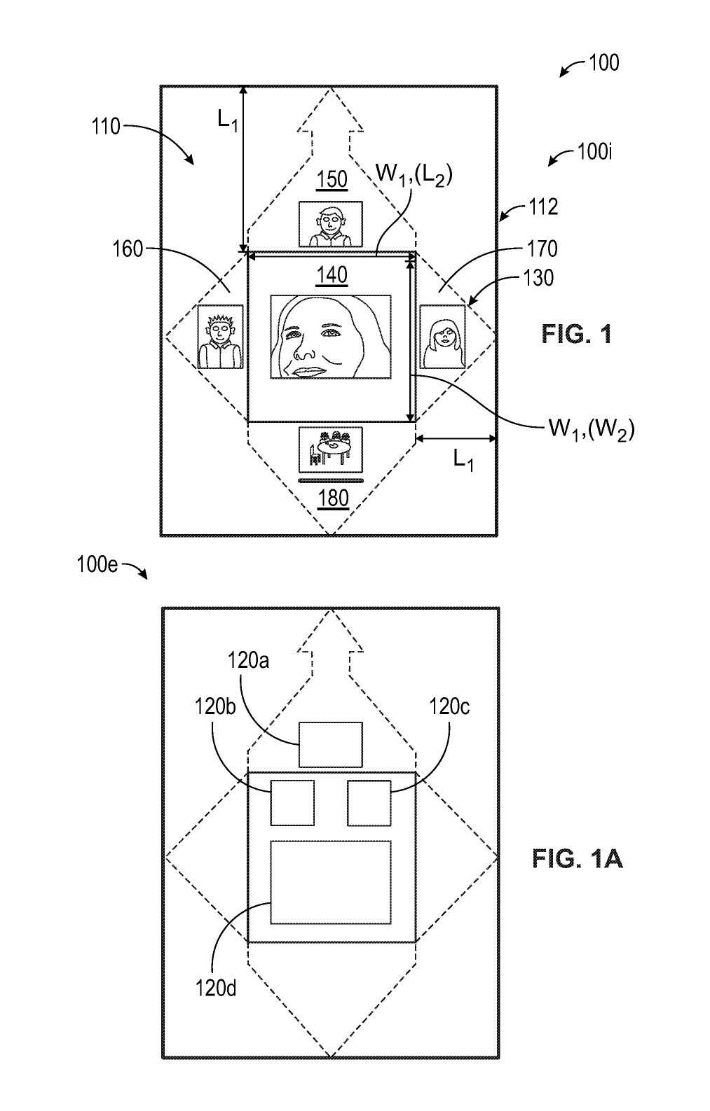

### B. General Features of an Example Customizable Greeting Card According to the Present Disclosure: FIGS. 1-6A

In FIG. 1, a schematic representation depicts a customized greeting card applied to a paperboard template 100. The paperboard template 100 comprises a first portion 110 and a second portion 120. The first portion 110 is differentiated from the second portion 120 by a separation border 130.

In the depicted example, the first portion 110 is the outer region of the paperboard template 100. In general, the paperboard template 100 can be comprised of a foldable material. The foldable material can be sized and received for use by a printer. In many instances, the foldable material may be a form of paper but alternatives are possible.

In the depicted example, the outer perimeter 112 of the first section 110 is consistent with the dimensions of standard sheets of paper. By “standard sheet” what is meant is paper that is available for use in a printer. For example, a sheet of paper with the following dimensions: 8.5 inches×11 inches (letter), 8.5 inches×14 inches (legal), 11 inches×17 inches, A0, A1, A2, A3 and A4 are representative standards. However, alternatives are possible.

Referring to FIG. 1A, the paperboard template includes an exterior surface 100e located on an opposite surface of an interior surface (FIG. 1) 100a. As depicted, the exterior surface includes a plurality of printable regions configured to receive postage and mailing information when the second portion 120 is detached from the first portion 110 and folded in the enclosed envelope 115. For example, a first exterior printable region 120a and a second exterior printable region 120b can be orientated to receive a sender's return address; and a third exterior printable region 120c can be oriented to receive the postage. A fourth exterior printable region 120d can be oriented to receive the card recipient's address. Alternative orientations of the depicted printable regions are possible.

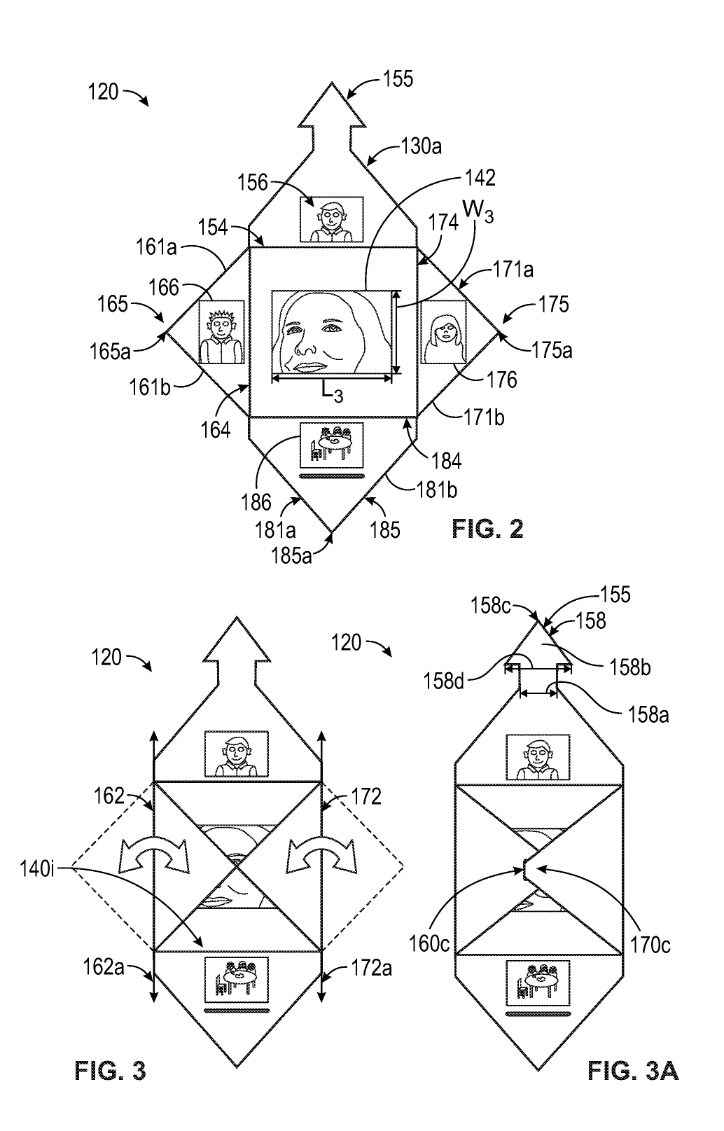

In referring to FIGS. 2-3A, the inner perimeter of the first portion 110 is defined by the separation border 130. In general, the separation border 130 can be visually indicated by a line 130a. In alternative examples, the line 130a can be a series of perforations in the paperboard template 100. The series of perforations reduces the structural integrity of the paperboard template 100 along the separation border 130. Thus, a user can more easily separate the first portion 110 from the second portion 120.

The second portion 120 comprises a plurality of panels: a central panel 140, a top panel 150, a first side panel 160, a second side panel 170, and a bottom panel 180. The top panel 150, the first side panel 160, the second side panel 170 and a bottom panel 180 are each connected to a respective side of the central panel 140.

The central panel 140 is oriented approximately in the center of the second portion 120. As depicted, the central panel 140 also is oriented approximately in the center of the first portion 110. The central panel 140 includes a center printable area 142 configured to receive data in the form of text or images.

In general, the boundary of central panel 140 is defined by a central panel outer perimeter 144. Referring to FIG. 2, the central panel outer perimeter 144 is defined by a plurality of seams that joins each panel 150, 160, 170, and 180 to the central panel 140. For example, the central panel 140 and the top panel 150 are connected by a top panel seam 152. The central panel 140 and the first side panel 160 are connected by a first side seam 162. The central panel 140 and the second side panel 170 are connected by a second side seam 172. The central panel 140 and the bottom panel 180 are connected by a bottom seam 182.

In general, each panel includes a length-dimension (L1) and width-dimension (W1). Further, the length-dimension is oriented in a direction perpendicular to the width-dimension. Accordingly, in general, the length-dimension (L1) and width-dimension (W1) can be used to derive an area-dimension for each panel.

As depicted in FIG. 2, for the top panel 150, first side panel 160, second side panel 170 and bottom panel 180, the respective width (W1) is directed along the respective base-end 154, 164, 174, and 184 of each panel. Similarly, for the top panel 150, first side panel 160, second side panel 170 and bottom panel 180, the respective length-dimension (L1) spans the distance between a respective base-end and the apex of a free-end for that respective panel.

In general, the orientation of the central panel 140 relative to one of the perimeter panels (150, 160, 170, and 180) indicates that the base-end width-dimension (W1) of a respective panel can also be the length-dimension (L2) of the central panel. Similarly, the width-dimension (W1) of a respective base end can be the width-dimension (W2) of the central panel. Accordingly, in general, the length-dimension (L2) and width-dimension (W2) can be used to derive an area-dimension for the central panel 140. As depicted in FIGS. 1-6, the central panel 140 has a quadrilateral shape. However, alternative geometric shapes are possible.

The top panel comprises the top panel base-end 154, a top panel free-end 155, a top panel printable region 156, and a securing member 158. The top panel base-end 154 is a region of the top panel that connects the top panel 150 to the central panel 140 at the top panel seam 152. In the depicted example, sides 151a, 151b of the top panel 150 converge to an apex 155a.

The top panel 150 is configured to fold around the top seam axis 152a at the top panel seam 152, inwardly towards an interior surface 140i of the central panel 140. As depicted, the top panel base-end 154 and top panel seam 152 are a straight line. In alternative examples, the seams (152, 162, 172, and 182) may comprise multiple lines or a curve, spanning the width-dimension of the respective panel.

The top panel 150 includes the top panel printable region 156. In general, the printable region is a region that is capable of receiving any text or graphic message from a printer. Each panel can have a printable region. In addition, the printable region on each panel can include an area dimension. In one example, the area dimension is determined by a length-dimension (L3) and width-dimension (W3) of the printable region 142. In another embodiment, the printable region 142, 156, 166, 176, and 186 can be a circular printable region including a radius dimension.

As depicted, the top panel includes a top panel free-end 155. When the first portion 110 is separated from the second portion 120; the top panel free-end 155 is not connected and extends radial away from the top panel base-end 154. By “extend radially,” it is meant the free-end 155 is oriented in a direction extending away from the base end of a respective panel. When a user attempts to convert the second portion 120 into a fully enclosed envelope 115, the top panel free-end 155 rotates inward toward the central panel 140.

The top panel free-end 155 comprises a securing member 158 including a shaft 158a and a notch 158b. The shaft 158a extends radially to a notch apex 158c of the top panel free-end 155. The notch 158b is connected at a distal end of the shaft 158a. As depicted, the notch 158b includes a notch base 158d having a width-dimension. The sides of the notch 158b converge to the notch apex 158c. As depicted, the structure of the notch 158b resembles a triangle. Alternative configurations of the securing member 158 are possible.

The first side panel 160 is located on a side of the central panel 140. The first side panel 160 is connected to the central panel 140 at the first side seam 162. The first side seam 162 is configured to fold around a first side seam axis 162a, inwardly towards an interior surface 140i of the central panel 140. In the depicted example, sides 161a, 161b of the first side panel 160 converge to an apex 165a and the first side panel free-end 165. For example, the first side panel 160 includes a printable region 166. Alternative embodiments are possible.

The second side panel 180 is located on a side of the central panel 140. The second side panel 170 is connected to the central panel 140 at the second side seam 172. The second side seam 172 is configured to fold around a second side seam axis 172a, inwardly towards an interior surface 140i of the central panel 140. In the depicted example, sides 171a, 171b of the second side panel 170 converge to an apex 175a at the second side panel free-end 175. For example, the second side panel 170 includes a printable region 176. Alternative embodiments are possible.

Bottom panel 180 is located on an opposite side of the central panel 140, relative to the top panel 150. The bottom seam 182 is configured to fold around a bottom side axis 182a, inwardly towards an interior surface 140i of the central panel 140. Sides 181a, 181b of the second side panel 170 converge to an apex 185a at the bottom panel free-end 185. In another alternative example, the bottom panel 180 includes a printable region 186. Alternative embodiments are possible.

The bottom panel 180 defines a first securing member aperture 188. The first securing member aperture 188 is configured to receive the securing member 158. As depicted, the first securing member aperture 188 is a slit having a width-dimension. Alternative shapes of the first securing member aperture 188 are possible.

In general, securing the top panel 150 to the bottom panel 180 comprises engaging the top panel 150 to the bottom panel by using a first securing member 158 to pass through an aperture 188 (slit), defined by the bottom panel 158. For example, the shaft 158a of the first securing member 158 has a width-dimension, oriented in the same direction as the notch base 158d. A ratio of the width-dimension of shaft 158 to the width-dimension of the first securing aperture 188 is at least 0.5. In a further aspect of the example, the notch base 158d can be wider than the first securing member aperture 188 to help secure the first securing member 158, such that the first securing member 158 does not freely disengage the bottom panel 180 by passing back through the securing aperture 188. In another aspect of the example, the ratio of the width-dimension of the first securing member aperture 188 to the width-dimension of the notch base 158d is at least 0.5.

Referring to FIG. 3, in general, the first side panel free-end 165 is adjacent to the second side panel free-end, when the first side panel 160 and the second side panel 170 are folded inward. The first side panel 160 has been folded inward around the first side seam axis 162a at the first side seam 162 towards the interior surface 140i of the central panel 140. Similarly, the second side panel 170 has been folded inward around the second side seam axis 172a at the second side seam 172 towards the interior surface 140i of the central panel 140.

Referring to FIG. 3A, the first side panel 160 and the second side panel 170 overlap when the panels are folded towards the central panel 140. The first side panel 160 and the second side panel 170 can be secured when a second securing member 170c located at the second side panel free-end 175 passes through a second securing aperture 160c defined by the first side panel 160. Alternative examples are possible where the location of the second securing member 170c is located on the first side panel 160 and the second securing aperture 160c is located on the second side panel 170.

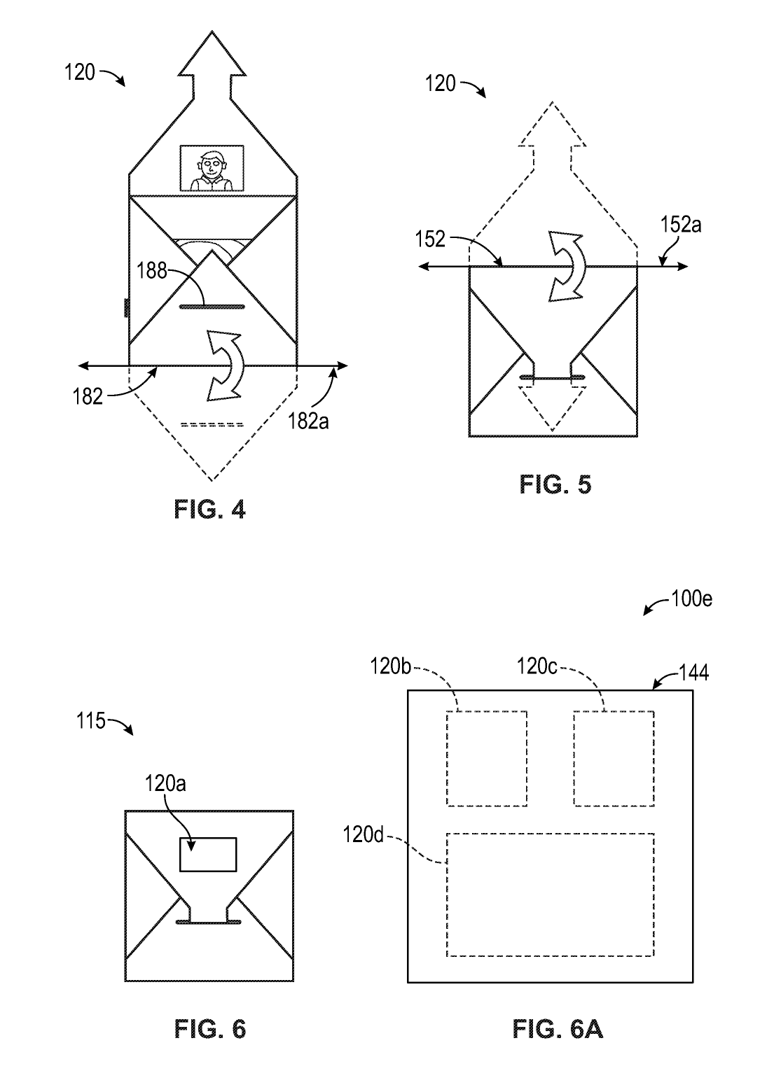

Referring to FIG. 4 and FIG. 5, the bottom panel 180 is folded inwardly towards the interior surface 140i of the central panel 140. The bottom panel 180 overlaps the first side panel 160 and the second side panel 170. Subsequently, the top panel 150 is folded inwardly towards the interior surface 140i of the central panel 140. To secure the second portion 120, the notch 158b of the securing member 158 passes through the first securing member aperture 188.

Depicting in FIGS. 6-6A, once all of the panels are secured, the second portion 120 has been converted into a fully enclosed envelope 115. The enclosed envelope is a normal quadrilateral. By “normal quadrilateral” what is meant is that each of the internal angles measure approximately 90 degrees. Accordingly, the printable regions 120a, 120b, 120c, and 120d are exposed and allow a user to print or write the mailing information.

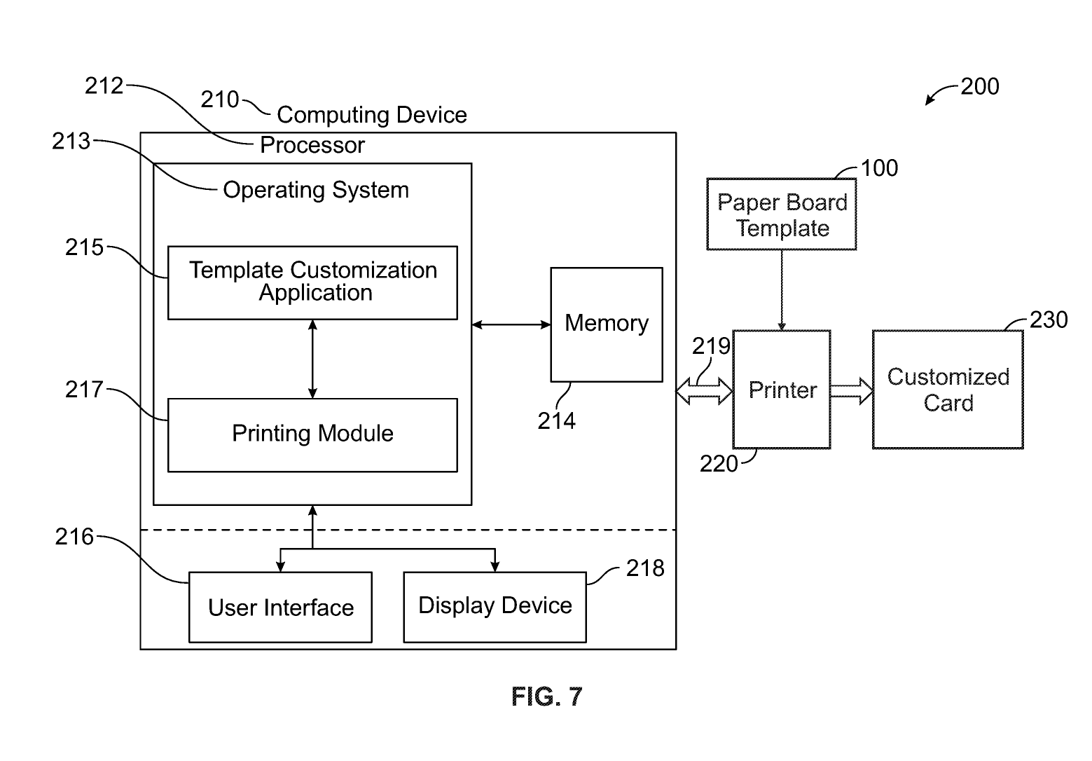

General System and Method of Providing an Example Customizable Greeting Card According to the Present Disclosure: FIG. 7.

Referring to FIG. 7, a system 200 for the creation of customizable greeting cards is depicted. The system comprises a computing device 210, a printing device 220, and a paperboard template 100. The resulting product from operating the system is the customized card 230.

The computing device 210 includes: at least one processor 212, a memory 214, a user interface 216, and a display device 218. In alternative examples, the physical embodiment of the computing device 210 can optionally be a portable electronic device, such as a laptop computer, a personal digital assistant, an electronic organizer, or a cellular phone. The computing device 210 may be configured as a computer that is capable of communicating over a communication network 119.

As depicted, a single memory 214 is shown for the computing device 210. Alternatives are possible where a wide variety of types and combinations of memory may be employed, such as computer-readable storage media examples of which include random access memory (RAM), hard disk memory, video memory, removable medium memory, and other types of computer-readable media.

The processor 212 may perform operations using electronically-executable instructions. For example, the processor 212 includes an operating system 213 that implements a template customization application 215. The template customization application 115 may implement a variety of functions callable to perform a variety of graphics processing functions. The template customization application 215 may be configured to render and manipulate various textual objects and graphical objects for printing on the paperboard template 100.

A printer module 217 facilitates communication between the computing device 210 and a corresponding printing device 220 and may operate to format user defined data related to a print job in a language and/or format understandable by the printing device 220.

For the purposes of example, the template customization application 215 performs tasks related to input from a user interface 216 on a display device 218 such as a monitor. In order to output the textual and graphic data received from the user interface 216, the template customization application 215 may be configured to interact with a variety of features provided via the operating system 213. A variety of other examples are also contemplated.

The computing device 210 is in communication with a printing device 220. The communication path 219 is optionally a communications cable, as described above, or it is a modem connection, or a wireless communications link, such as an infrared connection or a radio connection. Alternatively, the communication path 219 operates via a network, such as a local area network, a wide area network, or other communications link.

In general, the user defined data received from the user interface 216 and displayed on the display device 218 utilizes a screen layout that resembles the paperboard template 100 of FIG. 1. The display device 218 can be any device that provides a visual display to the user, thus allowing the user to view the user input updates through the template customization application 215. In this manner, the end user is able to visualize a final greeting card as it is being created. In applying the template customization application 215, a user can sequentially customize a printable region for each panel.

For example, when photographs are selected they may be sized by the end user or automatically sized to fit a selected printable region of the card thereby retaining the full image for the customer. Typically, a ratio of a central panel area dimension to another panel area dimension is at least 5.0. In an alternative example, the ratio of a central panel area dimension to another panel area dimension is at least 8.0. In an alternative example, the ratio of a central area dimension to another panel area dimension is at least 10.0.

The operations described may be carried out or performed in any suitable order to achieve the desired results. Additionally, in certain applications, at least a portion of the operations may be carried out in together (i.e. at the same time). Referring to FIG. 7, an end user will generally use the template customization application 215. Depending on a customization preference, the user can identify any text or graphics that will be incorporated into the greeting card (second portion 120). The text and graphics can be manipulated and entered using the user interface 216. As discussed, earlier the text can be entered in to the printable region of a respective panel.

For example, an end user will be provided the normal text editing options such as type of font, size of font, italics, underline, bold, color, highlights, and the like. Alternative methods of incorporating the text onto the card may also be incorporated. In some examples, a text block may be positioned onto the screen directing the end user to the location of the text and the sizing of the text.

Similarly, graphics can be added to a respective printable region to generate a customized panel. The graphics can be stored in the memory 214 or be accessed and downloaded for integration from an outside source such as an auxiliary memory drive or the internet. The picture may be automatically sized to fit into the desired panel.

By providing flexibility in methods of data input, the end user can customize the card as desired. Furthermore, by enabling each distinct panel to be a separate zone for receiving customized information each card can be manipulated such that only the base panel is utilized, or any alternative combination such as base and just the top panel, or base and first side panel, etc. Numerous permutations of configurations are possible. Once the desired card is produced, the layout is transmitted to the printing device 220.

Once the image is printed on the paperboard template 100, the first portion 110 is separated from the second portion 120, leaving the greeting card 230 (second portion) with its respective panels to be folded onto itself establishing a self-contained envelope. In alternative examples, an opposite surface of the template can be printed to receive recipient mailing information and/or postage information.

While the invention is described as incorporating a computer system for designing a customized greeting card, the paperboard template could be utilized by itself and a handwritten message could be provided and pictures attached to the respective panels.

What is claimed is:

1. A paperboard structure configured to be a customized greeting card displaying a customized message, said paperboard structure comprising:
a paperboard template comprising:
a first portion oriented to encompass a second portion, and the first portion being configured to detach from the second portion; and
the second portion comprising:
a top panel including a top panel base-end and a top panel free-end including a securing member,
a bottom panel including a bottom panel free-end and a bottom panel base-end defining a securing member aperture sized to receive the securing member,
a first side panel including a first side panel free-end and a first side panel base-end,
a second side panel including a second side panel free-end and a second side panel base-end, and
a central panel including: a top seam, a bottom seam, a first side seam, and a second side seam; the top panel base-end being connected to the central panel at the top seam, the bottom panel base-end being connected to the central panel at the bottom seam, the first side panel base-end being connected to the central panel at the first side seam, and the second side panel base-end being connected to the central panel at the second side seam.

2. The paperboard structure of claim 1, wherein the top seam, the bottom seam, the first side seam, and the second side seam are each configured to fold inwardly toward an interior surface of the central panel.

3. The paperboard structure of claim 2, wherein the central panel is enclosed by the top panel, the first side panel, the second side panel, and the bottom panel when each panel is folded inwardly towards the internal surface of the central panel.

4. The paperboard structure of claim 1, wherein the central panel comprises a quadrilateral shape.

5. The paperboard structure of claim 1, further comprising a perforated border between the first portion and the second portion at an outer perimeter of the second portion.

6. The paperboard structure of claim 1, wherein the securing member of the top panel free-end comprises a notch having a notch width-dimension and extending radially from the top panel free-end.

7. The paperboard structure of claim 6, wherein the ratio of a width-dimension of the securing member aperture of the bottom panel to the notch width-dimension is at least 0.5.

8. The paperboard structure of claim 7, wherein the ratio of the width-dimension of the securing member aperture of the bottom panel to the notch width-dimension is at least 1.0.

9. The paperboard structure of claim 1, wherein the second side panel includes a second securing member extending radially from the second side panel free-end; the first side panel including a second securing member aperture, oriented to receive the second securing member when the first side panel and the second side panel are folded inwardly towards the central panel.

10. A system for creating a personalized greeting card, said system comprising:
a computing device including:
a memory;
a user interface;
a display device, and
a processor in communication with the memory, the user interface and the display device, wherein the processor is configured to execute instructions to perform actions including:
provide a customized display on the display device resembling the configuration of a paperboard template,
receive input from the user interface,
provide input to the graphic display device, and
print the received input to the paperboard template;
a printer in communication with the computing device; and
the paperboard template comprising:
a first portion oriented to encompass a second portion; the first portion being configured to detach from the second portion;
the second portion comprising:
a plurality of perimeter panels including:
a top panel including a top panel base-end and a top panel free-end including a securing member,
a bottom panel including a bottom panel free-end and a bottom panel base-end defining a securing member aperture sized to receive the securing member,
a first side panel including a first side panel free-end and a first side panel base-end,
a second side panel including a second side panel free-end and a second side panel base-end, and
a central panel including: a printable region having an area-dimension, a top seam, a bottom seam, a first side seam, and a second side seam; the top panel base-end being connected to the central panel at the top seam, the bottom panel base-end being connected to the central panel at the bottom seam, the first side panel base-end being connected to the central panel at the first side seam, and the second side panel base-end being connected to the central panel at the second side seam; each of the top seam, the bottom seam, first side seam, and the second side seam being configured to fold inwardly toward an interior surface of the central panel.

11. The system of claim 10, wherein at least one perimeter panel of the plurality of perimeter panels has a printable region on the surface of the respective panel, the printable region having an area-dimension.

12. The system of claim 11, wherein a ratio of the printable region area-dimension of the central panel to the printable region area-dimension of the at least one of panel of the plurality of panels, is at least 5.

13. The system of claim 12, wherein the ratio of the printable region area-dimension of the central panel to the printable region area-dimension of the at least one panel of the plurality of panels is at least 8.

14. The system of claim 12, wherein the ratio of the printable region area-dimension of the central panel to the printable region area-dimension of the at least one panel of the plurality of panels is at least 10.

15. The system of claim 10, wherein the central panel is enclosed by the top panel, the first side panel and the second side panel, and the bottom panel when each panel is folded inwardly towards a surface of the central panel.

16. The system of claim 10, wherein the securing member of the top panel free-end comprises a notch having a notch width-dimension and a shaft; wherein the notch is located at a distal end of the shaft.

17. The system of claim 10, wherein the paperboard template is configured to receive printing data on an exterior surface and the interior surface from the printer.

18. A method of creating a personalized greeting card comprising:
providing a paperboard template comprising a top panel, a bottom panel, a first side panel and a second side panel, each panel being connected to a central panel;
receiving printing data including text data and graphic data using a computing device comprising a user interface;
displayed the received the printing data from the user interface; and
outputting the received the printing data onto the paperboard template.

19. The method of claim 18, further comprising:
separating a first portion of the paperboard template from a second portion of the template, and
folding the top panel, the bottom panel, the first side panel and the second side panel inwardly toward the central panel.

20. The method of claim 19, wherein folding the top panel, the bottom panel, the first side panel and the second side panel inwardly toward the central panel comprises securing at least two of the top panel, the bottom panel, the first side panel and the second side panel to each other.
